(19) United States
(12) Patent Application Publication
(10) Pub. No.: US 2008/0131255 A1
(43) Pub. Date: Jun. 5, 2008

(54) PALLETIZING SYSTEMS AND METHODS

(75) Inventors: Tommy Axel Hessler, Charlotte, NC (US); Lennart K.F. Johansson, Charlotte, NC (US)

Correspondence Address: ADAMS INTELLECTUAL PROPERTY LAW, P.A., Suite 2350 Charlotte Plaza, 201 South College Street, CHARLOTTE, NC, 28244, US

(73) Assignee: TRANSBOTICS CORPORATION, Charlotte, NC (US)

(21) Appl. No.: 11/947,389

(22) Filed: Nov. 29, 2007

Related U.S. Application Data
(60) Provisional application No. 60/867,971, filed on Nov. 30, 2006.

(51) Int. Cl. B65G 1/16; B65B 35/50; B65G 57/00

(52) U.S. Cl. 414/788.1; 414/799; 414/802; 901/14

(57) ABSTRACT

Palletizing systems and methods increasing the efficiency at which pallets of mixed products are built. The systems and methods include a pallet building module for receiving customer orders and generating pallet building instructions for arranging the products on the pallets, among other functions. The pallet building module is in communication with a number of robot cells that include source products and pallet building robots for building pallets based upon instructions generated by the pallet building module. The system includes other modules for system control including conveyor controllers, forklift controllers, and automatic guided vehicle controllers, among other controllers. Methods for building pallets of mixed product from source products within more than one robot cell.

### CROSS-REFERENCE TO RELATED APPLICATIONS

The present application claims priority to U.S. Provisional Patent Application No. 60/867,971 filed Nov. 30, 2006 and entitled “AUTOMATIC PALLETIZING APPARATUS AND METHOD.”

### TECHNICAL FIELD AND BACKGROUND OF THE INVENTION

The present invention relates generally to systems and methods for automating tasks, and more specifically, to palletizing systems and methods for receiving order information, collecting ordered products from among a group of products, and assembling those products together on pallets for shipment to a customer using more than one robot cell.

Supplier products that are used to fill customer orders are typically maintained in bulk quantities within a warehouse, distribution center or other storage facility. These various products are typically labeled with some form of unique product identification label or marking that provides specific product information. Common examples of product identifiers include UPC (Uniform Product Code) and SKU (Stock-Keeping Unit) labels. These product identifiers are typically referred to by a customer when placing an order with the supplier, and may also be used internally by a supplier to reveal the location of a specific product within the warehouse, thus facilitating readily locating requested items to fill customer orders.

In conventional order filling practices, order requests received by a supplier are typically filled by manually locating each type and number of requested products and gathering those products together to be packaged for shipping. Pallets are commonly used to provide a sturdy platform in which products are packaged together, and completed orders may be shrink-wrapped to prevent items from being separated from an order. Other platforms and containers may be used to package orders for shipment, and packages to be shipped to customers are typically loaded and stacked on a truck or other delivery vehicle based on delivery order.

Current palletizing practices require manual labor for product gathering and packaging, and thus are particularly labor intensive for large orders or orders that require different products to be arranged on a single pallet. Product gathering is typically carried out by workers who move about the warehouse and gather items using a forklift or hand truck according to a provided list, and then organize those items on a pallet for packaging. The requirement of manual labor in current palletizing practices limits the efficiency in which orders are processed and filled, increases the chances for order error, increases supplier operating costs and introduces the possibility for worker injury from the warehouse environment.

Thus, what is desired are systems and methods for automating order filling and palletizing that significantly reduce or eliminate the need for worker labor, thus increasing order fill efficiency, saving costs, reducing error and reducing workplace injuries.

### SUMMARY OF THE INVENTION

In various embodiments provided herein, the present invention provides systems and methods for automating palletizing to increase order filling efficiency.

In one embodiment, the present invention provides order fulfillment methods that work in cooperation with automated systems to optimize the flow of materials to build pallets of mixed products that match the requirements of an individual customer's order. In another embodiment, the present invention provides transportation optimization methods to optimize the flow of materials needed by order fulfillment software to build pallets of products for customer orders.

In yet another embodiment, systems and methods for automated palletizing are provided in which pallets or other packages are built by order. For each customer, a set of pallets is defined to meet an order. Pallet building begins by examining an order in a mainframe database, applying pallet building and optimizing logic, and creating an instruction list of how to arrange the individual items in a particular order to produce a set of pallets that comprise the order. The complete instruction set for each order is preferably computed and verified before physical pallet building begins. Orders may be filled based on delivery date, sales branch and route. Orders may be sorted by number and type of products needed to fill an order. Orders may be verified by product identifiers. Supplier product replenishing orders may be made as customer orders are placed and products are removed from inventory. Other information that may be obtained using product identifiers when building a pallet include the number of products per layer, the number of layers per pallet and the weight per product.

In yet another embodiment, the present invention provides systems and methods in which a pallet is built using more than one robot cell. The robot cells build pallets based on ordered product location information and other pallet building criteria. The pallets are preferably transported between robot cells using automatic guided vehicles, referred to herein simply as “vehicles,” that work in cooperation with the pallet building software and robot cells. The robot cells select ordered products from an inventory of diverse products according to a predetermined selection requirement and organize the selected products on the pallets. The vehicles and robots may be controlled by any suitable guidance and control system.

In yet another embodiment, the present invention provides a palletizing system including a collection of modules that communicate and perform pre-defined functions to collectively fill orders on pallets. Various modules perform tasks including: (1) pallet building using order data to build pallets; (2) configuring product distribution to optimize the throughput of the palletizing system by defining what products are loaded by each robot cell to minimize the movement of the pallet within systems as well as minimizing the need to move products from auxiliary stands; (3) monitoring the availability of free stands and, when required, moving pallets in and out of the system; (4) initiating order building for each pallet in the system and monitoring the progress of the pallet building and moving the pallet from robot to robot until the pallet is completely built; (5) replenishing robot cells with source product and ordering source product; (6) processing orders after they have been received by the production control interface and creating the actual orders; and (7) scheduling the start of pallet production by the palletizing system based on the number and type of pallets to be built, as well as other factors.

In yet another embodiment, the present invention provides a palletizing system in which the task of building a complete pallet including various products with different product identifiers is divided into more than one robotic cell such that a pallet is partially built at multiple cells of the system. Source pallets containing products to be loaded in a particular cell are optimized for a particular production run, so that a pallet is partially built in one cell with a certain mix of source pallets and then moved to a different cell with a different mix of source pallets, and then moved to a third cell, and so on, until the pallet is complete. A first cell includes a predetermined array of source pallets, while a second cell includes a different array of source pallets. The system may include any number of robotic cells and partially completed pallets are moved from one cell to the next by automatic guided vehicles. Vehicle movement between cells is programmed to maximize efficiency.

In yet another embodiment, the present invention provides a system for maximizing production by determining source pallet set-up for each robotic cell at the beginning of a pallet loading cycle and the changes to the arrangement of source pallets needed during that cycle to complete the palletizing of customer orders.

In yet another embodiment, the present invention provides a system including multiple robotic cells having at least one robot positioned therein. Positioned within or about each robotic cell are bulk product locations in which products as source pallets are stored, maintained and replenished according to a predetermined layout. Source pallets preferably include homogeneous product having a common product identifier, but may alternatively include various products having different product identifiers. Delivery pallets may follow a path within or about each cell.

In yet another embodiment, the present invention provides systems and methods for automating palletizing including a module for receiving product orders from customer management software and prioritizes the orders according to delivery destination and routing. The module uses the customer orders to define the configuration of the delivery pallet and send the configuration to a robot controller, or multiple robot controllers depending upon ordered products. Delivery pallets are moved between robotic cells using vehicles until a pallet is complete. Completed pallets are preferably delivered to location for packaging and loading. Palletizing may be initiated on demand or in a periodic batch process.

In yet another embodiment, the present invention provides a software algorithm to maximize production by determining an optimum source pallet set-up for each product selection run, and then changing the arrangement of source pallets during successive runs during a predetermined period to produce all needed delivery pallets using the divided pallet method of the invention, and the algorithm for determining the product sequence among work stations for building a particular delivery pallet.

Additional features and advantages of the invention will be set forth in the detailed description which follows, and in part will be readily apparent to those skilled in the art from that description or recognized by practicing the invention as described herein.

### BRIEF DESCRIPTION OF THE DRAWINGS

Various embodiments of the invention have been set forth above. Other embodiments and advantages of the invention will appear as the description of the invention proceeds when taken in conjunction with the following drawings, in which:

FIG. 1 is a flow chart illustrating systems and methods for automating palletizing in accordance with an embodiment of the present invention;

FIG. 2 is a plan view of a floor layout of the palletizing system of the present invention;

FIG. 3 is a perspective view of an automatic guided vehicle suitable for use with the palletizing system of the present invention; and

FIG. 4 is a schematic side elevation of a robot suitable for use with the palletizing system of the present invention.

### DESCRIPTION OF THE PREFERRED EMBODIMENTS AND BEST MODE

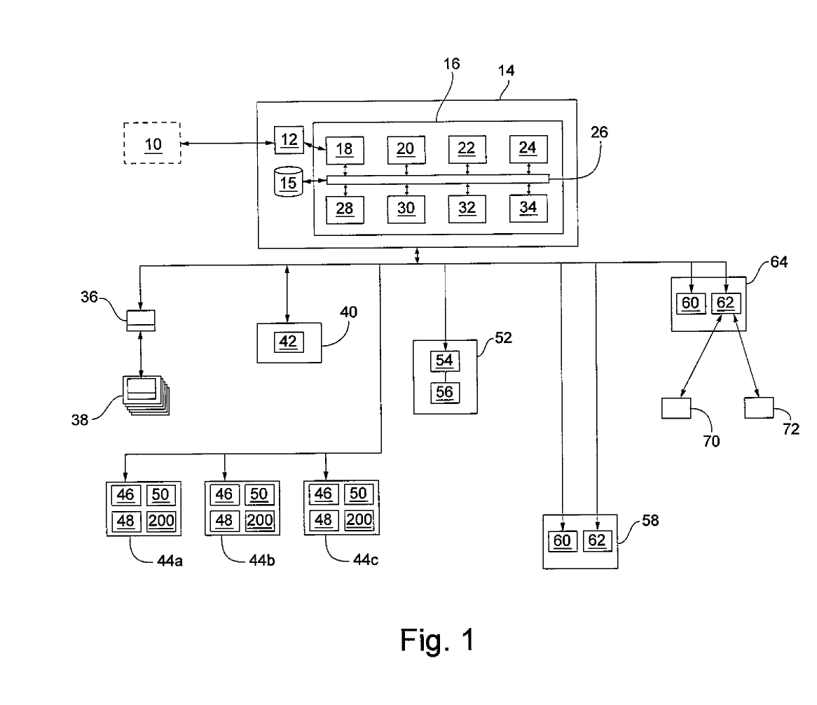

Referring now to the drawings, palletizing systems and methods for processing customer order information and building pallets of mixed products for delivery to a customer are described herein and illustrated in FIGS. 1-4. While these systems and methods are described with reference to a particular embodiment including specific pallet building examples and number of robotic cells, it is intended that the present invention cover other pallet building configurations without departing from the scope of the invention. The phrases “pallet building” and “building pallets” are used herein to refer to the arrangement of products on a pallet by the palletizing system of the present invention.

Referring now specifically to FIG. 1, orders are placed by customers and are received by a supplier through a customer information control system (CICS) transaction sever 10 operable for transmitting customer orders. The orders are received and processed by the supplier by a transaction interface module 12 located within a supplier's main server 14. Customer orders are transmitted on demand and are received and prioritized based on delivery date, delivery distance and sales branch, among other factors. The main server 14 further includes a database management transaction-SQL module (MS SQL) 15 for database support and a pallet building module 16 for optimizing the flow of materials required to build pallets of mixed products. The pallet building module 16 may also perform scheduling functions, inventory tracking, to/from moves, and provide a network and automatic guided vehicle interface.

The pallet building module 16 includes pallet building preparation and system control modules including, but not limited to, a production control interface module 18, a pallet controller module 20, a website management system controller module 22, and a logistics controller module 24. These modules communicate through an internal communication system 26 to pallet building and transportation modules including, but not limited to, an automatic guided vehicle system controller module 28, a robot system controller module 30, a fork lift system controller module 32, and a conveyor system controller module 34. Upon receipt of a customer order, the pallet building module 16 processes the order, runs programmed pallet building logic, begins a source product replenishment process, and begins the pallet building process.

Dispatched customer orders are sent to the pallet building module 16 as “dispatched” orders whose route information is known. These orders may change from the time that they are received to the time that they are filled. Changes may include product type, quantity, and desired delivery date, among other customer requests. Assigned priority by the supplier may also change during an order life cycle based upon the customer changes, source items in stock and delivery routes, among others. Updated orders are processed by the pallet building module 16 for re-prioritization and new pallet building instructions. The pallet building module 16 also checks to see if an order has already been filled prior to a change being requested. Orders and updated orders are checked to make sure that all fields required to begin the palletizing process are correctly filled, and orders with missing or incorrect information are rejected and sent back for correction.

Pallets are built from an instruction list generated by the pallet building module 16. The instruction list includes product identifiers and quantities, and instructions for arranging the products on a pallet. For each product identifier, for example each SKU, the pallet building module 16 determines the following information: the number of cases of a particular SKU per layer on a pallet; the number of layers of product per pallet, and; the weight of a product or the weight per case of product. SKUs may be sorted by package family codes where all SKUs with the same package family code have identical carton dimensions and weight.

Pallet building logic performed by the pallet building module 16 includes: subtracting items from an order where there are a sufficient number of items of the same SKU to comprise an entire pallet (single item pallets are built outside of the palletizing system of the present invention and the balance of the order consists of whole or partial pallets containing more than one SKU); assigning family codes (family codes may be assigned from the product identifiers); sorting the products by package family codes; computing the number of cases per pallet package family; sorting package families into those that are ordered in layered quantities and those that are not (product layers consist of complete layers of a single SKU and package layers consist of a complete layer of a single product package family code); sorting remaining loose items (loose items are preferably placed as the top one or two layers of a pallet); determining the percent of pallet completion for each package family code; determining full pallets and combined pallets; combining pallets by adding percent complete for each package family code; sorting cases by predetermined pallet level codes (e.g., lowest code on the bottom of the pallet, code ranking may be arbitrarily assigned); determining the physical configuration on the pallet layer for each package family using a pattern template; placing items with the same package family code on the first mixed layer without breaking up quantities in order to have the largest base area or platform for the second mixed layer; filling in mixed layers; and comparing the current height of the pallet to determine if an additional layer will exceed a predetermined maximum built pallet height.

The pallet building module 16 runs pallet building logic to determine the number of pallets required for an order. The logic is a volume calculation that takes each product's contribution to a full pallet, sums the contribution, and then divides by 100% (the volume of a full pallet). For example, if for a specific product SKU, there are 8 products on a layer and it takes 8 layers to make a full pallet, each product contributes 1/64^{th} or 1.56%, of the pallet volume. For each ordered product the above percentage is multiplied by the quantity ordered, then all products are added to arrive at a total percentage of all products. If the total of all products in the order is 356%, then the order would require 3.56 pallets, which is rounded up to the next whole number of pallets, and it would be determined that four pallets are required to build the order. Conditions that have may have an effect on the accuracy of the estimated value include the amount of loose products ordered and how close the calculation is to a full pallet (100%). Pallets are released for pallet building upon demand, and pallets may be marked with a pallet identifier for tracking within the palletizing process and pallet delivery.

Pallets to be built each day or for a predetermined build cycle are preferably known before the cycle begins. In alternative embodiments, new pallet builds may be introduced into a build cycle mid-span upon demand. Pallet build additions/deletions occur based on changes to an order from a customer or inventory issues and are processed within the pallet building module 16. Customer orders for a build cycle are received via a batch scheduler of the pallet building module 16, which runs optimizing algorithms to arrive at the best possible setup and product allocations in the robot cells for the build cycle while respecting any priority constraints. The allocation of what products are ordered and where and when placed are rearranged within an order; i.e., if an order requires four pallets in the main server order list, it requires four pallets after the palletizing system has devised its own version of the robot order list, as the case and pallet quantities remain the same. A purpose of the re-arrangement is not only to build pallets based on product codes and pallet building logic, but to build pallets with optimized throughput.

Products are arranged into a collection of layers of product and for each SKU the pallet building module 16 creates sets of product layers (share a common SKU) and package layers (mixed SKUs). Once product layers are determined, the next step is to combine all products remaining that have not been used in building the product layers. All order products that have the same “package code” are combined into new quantities of package family code products. The new quantities are then used to create “sets” of package layers. Each package layer has the same package code and comprises the case quantity required to form a full layer for that SKU package. All remaining products are considered “loose products” because they cannot be combined into a layer configuration which supports stacking. As stated above, loose products are placed as a top layer on a pallet.

“Mixed layers” comprise mixed products that do not have complete layer quantities. In order to increase the efficiency of building and reduce the number of pallets required, the pallet building module 16 may accommodate up to two mixed layers per pallet. While creating mixed layers, the module places the products on a mixed layer and makes a first validation as to the number of pallets actually required for the order. In other words, because only two mixed layers can be defined for each pallet, if there are more mixed layers required than pallets available, then the number of pallets may be increased. Note that this is the first validation attempt, and no layers have actually been placed on a pallet, and physical height limits have not yet been considered. A second validation takes place when the layers are physically placed on the pallets. The first pass in creating mixed layers attempts to place as many products on the first mixed layer of a pallet as possible without breaking up quantities. This ensures that the largest ‘base area’ or platform is created for a second mixed layer, if required. The second pass then tries to place any remaining products on the first mixed layer, breaking up quantities as required. If there are products still to be placed after having exhausted the available area on the first mixed layer, then the module attempts to place products on the second mixed layer of each pallet. It should be noted that the module attempts to distribute the loading of the mixed layer evenly across all pallets. In other words, a second mixed layer is not attempted until all available space on the first mixed layer of all of the pallets in the order has been exhausted.

Products are placed on a pallet according to pallet level code, and the product layers and package layers are sorted according to level code. The module selects a “layer set” from either product layers or package layers that have the lowest level code and places it on the first pallet. A layer set comprises all product layers with the same SKU, or all package layers with the same package code. The process is then repeated until all layers have been placed. For each iteration, the module selects the pallet with the least amount assigned to it as the pallet to use in placing the next set of layers. This results in even layer distribution among the pallets. When placing a layer on a pallet, the module compares the current height of the pallet and determines if the addition of the layer will exceed the maximum height of a pallet, for example about 72 inches. If no pallet can be found that can accommodate the layer, then the number of pallets for the order is increased and the pallet building logic is repeated.

A further task of the module is to determine the actual physical coordinates and orientation for each package to be placed on a pallet. For product layers and package layers there are pre-defined patterns that are programmed into the module to calculate the coordinates. For mixed layers, the module determines the coordinates of each product as it defines the mixed layer. After all layers have been successfully placed on pallets within the module, the physical coordinates of each product are then persisted to the database. This information is transmitted to the robots by way of instruction in order to physically build the pallets. Certain SKUs may be excluded from the automatic palletizing system due to their package configuration or relative infrequency of use. These SKUs may then be set aside for manual picking. When these SKUs are part of an order, the system processes the order without the manual pick products, which may be flagged on the order. When the robot building portion of the order is complete, the delivery pallet is delivered to the out-feed area, and the missing SKUs printed on the label are manually selected and added to the delivery pallet.

A step in building pallets includes maintaining an adequate supply of source pallets. Source pallets include bulk quantities products and are positioned at predetermined locations within the pallet building area. Source pallets may be located within predetermined robotic cell areas within reach of the pallet building robot, and are also stocked elsewhere and delivered to robot cells as needed. The pallet building module 16 not only receives and processes customer orders and generates pallet building instructions, but also generates restocking orders as products are removed from inventory. This may occur both as a start-up function for a build cycle, as well as on an ongoing basis while products are consumed by the order building process. At any given moment, it is likely that some pallet positions may be empty, and are reserved for slow moving inventory to be moved into, and out of a pallet loading cell. Restocking begins by determining what product type will be required, and during which build cycle a product needs to be available. This may be performed based on the sequence in the optimized robot order list for building the day's production. Delivered pallets that are incorrect or returned for other reasons to the supplier may be scanned and entered into the palletizing system and made available as source product. The system can accept full or partial pallets. The module further maximizes production by determining the source pallet set-up for each robot cell at the beginning of the day or build period and changes to the arrangement of source pallets needed during the day to produce the days pallets using the divided method and the algorithm for determining the sequence among work stations for building a given pallet. The logic minimizes the number of moves and maximizes throughput.

A method for replenishing source pallets to the robot cells, and moving requested pallets within the palletizing system in general, includes delivering a required SKU and a desired location to a worker or vehicle in the system from the pallet building module 16. In the case of worker delivery, the SKU and location are delivered to a worker through a message or display, such as an RF display mounted on a forklift, vehicle, handtruck, dolly or other suitable vehicle for moving pallets. If, by way of example, a forklift is used, the forklift operator retrieves the needed product and delivers the product to the appropriate conveyor or robot cell. If the SKU to be retrieved is not in stock, an entry is made into the palletizing system and that product ordered. A product that is out-of-stock is labeled with that identifier so that future orders and orders for later in a build cycle reflect the lack of source product for pallet building. New source product is entered into the palletizing system and made available for pallet building. Orders that require an out-of-stock product may be re-prioritized or filled without the out-of-stock product. Predetermined source products may also be used to replace out-of-stock products to maintain the predetermined number of ordered products in existing pallet building instructions, thus not requiring a re-calculation of product quantity but simply a substitution of one product for another.

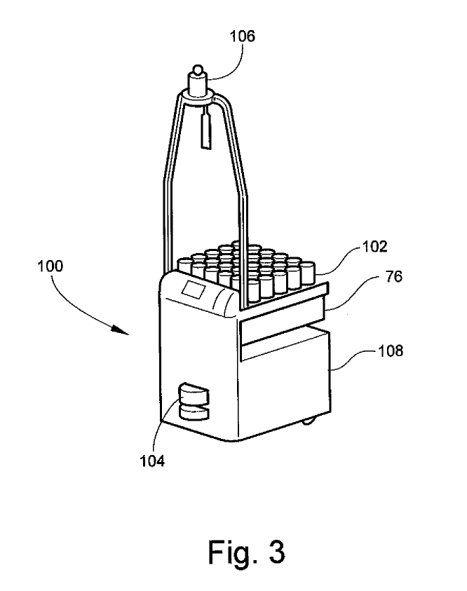

The automatic guided vehicle (AGV) system controller module 28 of the pallet building module 16 communicates with a vehicle system controller 36, which controls vehicle controllers 38 of individual AGVs, such as laser guided vehicles. Communications to the guided vehicles may occur through RF transmission or any other means for wired or wireless communication. The AGV system controller module 28 dispatches an available AGV (see 100 at FIG. 3) to pick up a pallet and deliver it to the appropriate location either in a robot cell, or to a storage stand commonly used for low frequency SKU's. In alternative embodiments, the AGVs 100 may be controlled directly by the AGV system controller module 28. The AGV 100 of FIG. 3 is shown carrying a pallet 76 having product 102 arranged thereon.

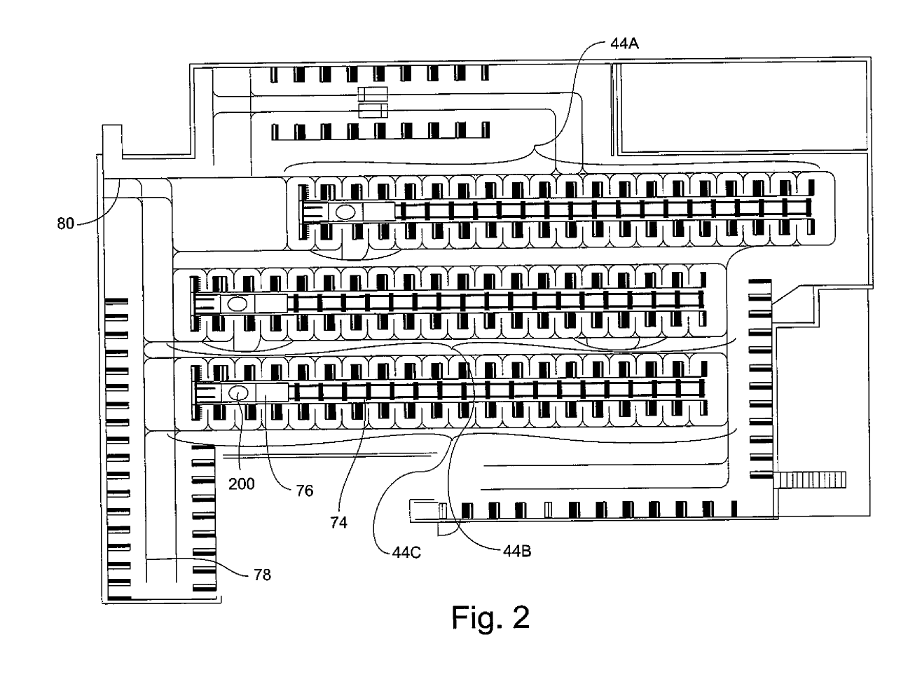

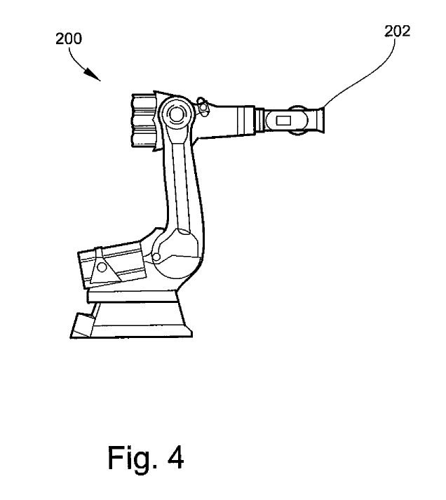

Pallets are built according to the instructions from the pallet building module 16. Referring specifically to FIG. 2, a plan view of a floor layout of a palletizing system is shown. While the layout shown includes three robot cells 44a, 44b, and 44c arranged in parallel, a pallet building system may include any number of robot cells arranged in any configuration. The number of robot cells may be determined by the size of the facility, number of unique SKUs, product sizes, gripping requirements, reach of the robot, and number of orders filled per build cycle, etc. Each robot cell 44 is in communication with the main sever 14 and pallet building module 16, and is preferably controlled through a robot system controller module 30. Each robot cell 44 includes at least one robot (see 200 at FIG. 4) capable of receiving commands, selecting products from source products 77 (preferably arranged on pallets) within that robot's cell, and placing those items on a delivery pallet based on the arranging instructions. Each robot 200 is mounted on a slide and source pallets are positioned around the robot slide 74 within reach of the robot's grasp. A delivery pallet 76 is fitted to the robot 200 and moves with it on a carriage. A robot cell transfer conveyor 78 is located at the end of the robot cell to move pallets into or out of a cell. The pallet building sequence begins by the robot picking an empty pallet 76 off an empty pallet stack and placing it onto the robot picking position moving with the robot. The robot 200 then moves on the slide from source pallet to source pallet—each containing a discrete product SKU—retrieving the products as required to make up the delivery pallet.

Once the robot 200 has finished loading product available to it for a pallet, the robot moves to the end of the slide 74 and sets the partially (or fully) complete delivery pallet on the robot cell transfer conveyor 78. The system then indexes the robot cell transfer conveyor 78, and directs an available AGV 100 to pick up the complete or partially completed pallet. After pickup, the AGV 100 is directed to deliver the pallet 76 to the next picking robot cell or to an outbound conveyor. The AGV places the pallet in the infeed of the robot cell transfer conveyor, and then performs its next process step. Once the pallet is on the robot cell transfer conveyor, it is indexed and positioned into the robot picking position and fitted to the robot on the slide. The picking process re-commences and the product-picking robot moves on the slide from source pallet to source pallet, picking the products required to make up the delivery pallet. Once complete, the delivery pallet is returned to the robot cell transfer conveyor 78 and indexed to the outfeed position. Once again, an AGV 100 is directed to pick up the partially completed delivery pallet and transport it to another robot cell until the whole delivery pallet has been built. Thus, delivery pallets are moved by AGVs from robot cell to robot cell with a high degree of flexibility to fill a delivery pallet.

Completed pallets are picked up by an AGV 100 and transferred to a predetermined outfeed conveyor 80. Completed pallets are stretch wrapped or otherwise packaged for shipping either during transport on the outfeed conveyors or at a packaging location. Printed labels are applied to packaged pallets for identification and tracking purposes. Labels may include product, customer and delivery information, among other information. Pallets that are packaged and labeled on an outfeed conveyor may have their labels scanned and displayed, such as on a display of a forklift, so that a forklift operator can identify the pallet and transfer it to a staging area for shipping. Forklifts are in communication with the pallet building module 16 through a forklift terminal 52 that includes a bar code scanner and user interface 54 and bar code driver 54 for both reading and inputting product identifier information. Packaged pallets may also be moved to the staging area using AGVs, further automating the palletizing system.

Referring to FIG. 3, the AGVs 100 are preferably a “lift deck” type, designed for pallet transport and have a three-wheel configuration-one steer/drive unit and two support wheels under the straddle legs, such as manufactured by Transbotics Corporation of Charlotte, N.C. The vehicles are equipped with a laser scanning bumper 104 in the front of the vehicle, flashing lights 106, battery disconnects and emergency stop buttons, all of which are conventional. The front bumper may include a laser type PLS mounted within a protective enclosure. Two detection areas are programmed in the PLS logic to provide a long distance slow-down range and a short distance emergency-stop (e-stop) range. If the short distance e-stop range is broken, the vehicle enters an c-stop condition. Emergency stop buttons are located on each corner of the vehicle. The buttons must be manually reset before the vehicle re-starts. Activation (depressing the button) causes the vehicle to stop abruptly. An additional reset button may also be activated in conjunction with the emergency stop button reset.

An AGV suitable for use herein may be of any type that functions to pick up at least one pallet at a time from an inventory of pallets or from a conveyor and is adapted to transport the pallet. The AGV may include navigation components such as a rotating laser scanner head that triangulates its position with the aid of reflectors strategically placed throughout the area. The scanner transmits a laser beam and receives the reflected beam, from which it measures angles between the reflectors and calculates its actual position. This information is updated many times per second. The position information may be transmitted by a communications link such as an RS-422 serial link to the AGV controller.

Referring to FIGS. 1 and 4, the robot 200 may include a vision system (see FIG. 1 at reference number 50) physically mounted near the end effector 202 to detect movement of the load which may have occurred on the delivery pallets during transportation between robot cells or during source pallet delivery. If product movement is detected by the vision system, the system computes the amount of movement relative to the predetermined placement coordinates, and instructs the robot to compensate for precise positioning when engaging a product for extraction from the source pallet during the building of the delivery pallet. Thus, the vision system allows the robot loading to dynamically compensate for product movement in the system. The vision system also provides information for updating the precise location of the products on the delivery pallet as changes occur through load shifting.

The vision system 50 includes at least one camera, for example two CCDs per robot, and a dedicated computer 48 and controller 46 running frame grabbing hardware for capturing images and processing errors. Error information is transmitted to the robot via Ethernet or other data transfer protocol. Software executes the correction, and communicates the information to the robot. The system also knows the source pallet configurations, and is able to determine the approximate height of the product to be grabbed. The vision system captures an image of the case that it wishes to extract, compares it with its database of known products to recognize the shape, and then computes the position and angle (skew). The variation between the expected position and the actual position is sent to the robot as an error correction. The robot uses this information to accurately position the end effecter for precise extraction.

The vision system 50 software uses algorithms to reduce the effects of inconsistent lighting, and variations in package dimensions due to damaged cartons, etc., to produce a high probability of recognition. The parameters used for this filtering can be set on-site for optimal results in the environment within which the vision system is to be used. Vision system calibration during set-up, once completed, remains calibrated unless an unexpected collision takes place between the vision system and an obstacle. In this case, recalibration is carried out, either by automatic means such as by focusing the camera to a known, fixed target with absolute coordinates, or by manual methods following a step-by-step procedure.

The robot tows a carriage along the slide, on which is contained the delivery pallet for building the orders. On the opposite side of the robot, a tool magazine holds the various end effectors used for the different package types. The robot preferably has the ability to change end effectors based upon the product type to be handled. The robot control software commands the robot “X” to proceed to pallet position “Y”, then reach out and use the end effecter to extract case “Z” from the source pallet. Once the robot has reached the picking position, the vision system captures the image, recognizes the edges of the SKU package desired, and adjusts its position accordingly so the end effecter can make a precise clamp onto the product package.

The end effecter 202, commonly known as “tooling”, “end-of-arm tooling” or “grippers” in various industries, is located at the end of the robot's arm that is used to engage the products. Any suitable type of mechanism may be used, depending on the size, weight, fragility and construction of the product, whether it or they are contained in a package and, if so, the type and construction of the package within which it is contained. In one preferred embodiment, the products are extracted from the source pallet with an end effecter equipped with vacuum controls, such as suction cups, to engage, lift and move the product. Vacuum controls are manipulated with pneumatic valves or solenoids to actuate one, or many of the numerous suction cups, depending on the size and weight of the package to be lifted. The end effectors are designed to extract one, two, or more individual products simultaneously to ensure maximum throughput. The end-of-arm tooling is preferably capable of picking up and placing more than one case but less than a full layer at one time. Traditional robots pick and place one case at a time. Traditional palletizers pick up and place an entire layer at a time.

Conveyors are used to transport source pallets from a warehouse to the palletizing system, and from the palletizing system to an outfeed area, such as a stretch wrapping station. Forklifts and AGVs may be used in place of conveyors or may be used to load the conveyors. Referring again to FIG. 1, the inbound conveyors 58 and outbound conveyors 64 are in communication with the pallet building module 16. The inbound conveyors 58 include modules for control and displaying information. Specifically, the conveyor includes panel computers 62 with “Soft PLC” applications for control software and a driver 60 for driving displays. These panel PC's are preferably equipped with remote I/O capabilities to interface with operator controls, process controls, and process feedback devices. The conveyors, such as the outbound conveyors 64 use localized PC's and spare I/O and communication channels to control devices such as a printer, label maker and label applicator (referred to together at reference number 70, stretch wrapper 72, and marquee(s). A commonly used PLC application is TwinCat PLC from Beckhoff Automation. Intermediate (small) conveyor systems may be utilized to assist transferring the delivery pallets from the robot's slide to the AGV, and vice versa, and is controlled via I/O from the robot's controller. Another small conveyor may be used to facilitate removing infrequently used pallets from the palletizing system to make space available for required source pallets.

While palletizing systems and methods have been described above with reference to particular embodiments and examples, it is intended that various details of the invention may be changed without departing from the scope of the invention. Furthermore, the foregoing description of the preferred embodiment of the invention and best mode for practicing the invention are provided for the purpose of illustration only and not for the purpose of limitation.

What is claimed is:

1. A palletizing system, comprising:
(a) a pallet building module for receiving a customer order for products and generating pallet building instructions from the order;
(b) multiple robot cells in communication with the pallet building module and adapted to carry out the pallet building instructions, the robot cells comprising a plurality of source products and a robot for retrieving the products from among the source products and arranging the products on at least one pallet, and wherein each of the at least one pallets is assembled by more than one robot cell; and
(c) at least one automatic guided vehicle in communication with the pallet building module and operable for transporting the at least one pallet between robot cells and within the palletizing system.

2. The palletizing system according to claim 1, wherein each of the source products are labeled with a product identifier and each of the at least one pallets include more than one product identifier.

3. The palletizing system according to claim 1, wherein the pallet building instructions comprise assigning family codes to the products, sorting the products by the family codes, sorting the products into layers and determining the physical configuration of each layer of the at least one pallet.

4. The palletizing system according to claim 1, wherein the pallet building instructions comprise comparing product layer height to a maximum pallet layer height.

5. The palletizing system according to claim 1, wherein the number of pallets required for the customer order is determined by the pallet building module.

6. The palletizing system according to claim 1, wherein the pallet building module processes pallet build additions and deletions based on changes to the order from a customer and source product inventory.

7. The palletizing system according to claim 1, wherein the products are arranged on the at least one pallet into product layers that share a common product identifier and package layers that have mixed product identifiers.

8. The palletizing system according to claim 1, wherein the pallet building module determines the physical coordinates and orientation for each of the products to be placed on the at least one pallet.

9. The palletizing system according to claim 1, wherein each of the at least one pallets are collectively assembled by the multiple robot cells.

10. A method for building a pallet of mixed products, comprising:
(a) providing a pallet building module for receiving a customer order for products and generating instructions for arranging the products on the pallet;
(b) building a first portion of the pallet at a first robot cell comprising first source products and a first robot including end-of-arm tooling;
(c) transporting the pallet to a second robot cell using an automatic guided vehicle; and
(d) building a second portion of the pallet at the second robot cell comprising second source products and a second robot including end-of-arm tooling;
wherein the instructions are communicated from the pallet building module to the first and the second robot cells.

11. The method according to claim 10, wherein the automatic guided vehicle is controlled by the pallet building module.

12. The method according to claim 10, wherein the first and the second source products are labeled with a product identifier.

13. The method according to claim 10, wherein the instructions comprise assigning family codes to the products, sorting the products by the family codes, sorting the products into layers and determining the physical configuration of each layer on the pallet.

14. The method according to claim 10, wherein the pallet building instructions comprise comparing product layer height to a maximum pallet layer height.

15. The method according to claim 10, wherein the pallet building module processes pallet build additions and deletions based on changes to the order from a customer and source product inventory.

16. The method according to claim 10, wherein the products are arranged on the pallet into product layers that share a common product identifier and package layers that have mixed product identifiers.

17. The method according to claim 10, wherein the pallet building module determines the physical coordinates and orientation for each of the products to be placed on the pallet.

18. A method for building a pallet of mixed products, comprising:
(a) providing a pallet building module for generating instructions for dividing the task of building a complete pallet including the mixed products into more than one robot cell;
(b) building the pallet with the more than one robot cell; and
(c) transporting the pallet between robot cells using an automatic guided vehicle.

19. The method according to claim 18, further comprising the step of providing source products to the more than one robot cell prior to building the pallet.
